(19) United States
(12) Patent Application Publication
(10) Pub. No.: US 2021/0097595 A1
(43) Pub. Date: Apr. 1, 2021

(54) HAIR CODE

(71) Applicant: The Procter & Gamble Company, Cincinnati, OH (US)

(72) Inventors: Robert Joseph SENIOR, III, Cincinnati, OH (US); Katherine Marie MOEGGENBERG, Silverton, OH (US); Aaron Salim GILANI, Indianapolis, IN (US)

(21) Appl. No.: 16/587,224

(22) Filed: Sep. 30, 2019

(51) Int. Cl. G06Q 30/06; G06F 16/9535

(52) U.S. Cl. CPC G06Q 30/0631; G06Q 30/0641; G06F 16/9535

(57) ABSTRACT

A method of providing a consumer a hair code, the steps of the method including (a) obtaining information regarding attributes of the consumer's hair and scalp; (b) using the information to generate a hair type code, a cuticle health code, and a scalp health code; and (c) combining the hair type code, cuticle health code, and scalp health code to create a hair code.

### TECHNICAL FIELD

One aspect of the invention relates generally to methods of generating and using a unique consumer hair code, making product recommendations, and connecting consumers to others with the same hair code.

### BACKGROUND

Consumers shopping for hair care products have a dilemma. On average, there are over 1,800 new hair care products each year, but the average consumer spends about 2 minutes in the shopping aisle selecting hair care products. On any given day, only 1 in 10 consumers claim to be having a great hair day. This is all to say that consumers are struggling to navigate the shopping aisle to find the right products. Surveys show that over 9 out of 10 consumers wish they could find out while being in the aisle which products work best for their hair. In addition, surveys show that consumers are very willing and tend to experiment with different hair care products and brands. Meanwhile, consumers are losing trust in the recommendations of known brands and relying more on the recommendations for hair products from stylists. However, our research shows that people most trust recommendations from others who have similar hair types.

Surveys and websites exist in which a consumer can answer questions and then hair care product recommendations are made. However, without giving any feedback to the consumer about their particular hair type, product recommendations are made, and that is the end of it.

Thus, there is a continuing need for a more holistic way to provide consumers information about their hair and scalp, and importantly, to connect consumers to others who have the same or similar hair or scalp type, so that the best and most trusted product recommendations can be made.

### SUMMARY OF THE DISCLOSURE

A method of providing a consumer a hair code, comprising the steps of (a) obtaining information regarding attributes of the consumer's hair and scalp; (b) using the information to generate a hair type code, a cuticle health code, and a scalp health code; and (c) combining the hair type code, cuticle health code, and scalp health code to create a hair code.

### BRIEF DESCRIPTION OF THE DRAWINGS

While the specification concludes with claims, it is believed that the same will be better understood from the following description taken in conjunction with the accompanying drawings wherein like numbers illustrate like elements throughout the views and in which:

FIG. 1 is a chart showing the choices for hair type, cuticle health, and scalp health available to the consumer while using the hair code system as in the claimed method.

FIG. 2 depicts a display of the claimed method in use.

FIG. 3 depicts a display of the claimed method in use.

FIG. 4 depicts a display of the claimed method in use.

FIG. 5 depicts a display of the claimed method in use.

FIG. 6 depicts a display of the claimed method in use.

FIG. 7 depicts a display of the claimed method in use.

FIG. 8 depicts a display of the claimed method in use.

FIG. 9 is a flowchart depicting a consumer interacting with the hair code system.

The embodiments shown in the drawings are illustrative in nature and are not intended to be limiting of the invention defined by the claims. Moreover, individual features of the drawings and the invention will be more fully apparent and understood in view of the detailed description.

### DETAILED DESCRIPTION

While the specification concludes with claims that particularly point out and distinctly claim the invention, it is believed the present invention will be better understood from the following description.

The present invention can comprise, consist of, or consist essentially of the essential elements and limitations of the invention described herein, as well any of the additional or optional ingredients, components, or limitations described herein.

Reference within the specification to “embodiment(s)” or the like means that a particular material, feature, structure and/or characteristic described in connection with the embodiment is included in at least one embodiment, optionally a number of embodiments, but it does not mean that all embodiments incorporate the material, feature, structure, and/or characteristic described. Furthermore, materials, features, structures and/or characteristics may be combined in any suitable manner across different embodiments, and materials, features, structures and/or characteristics may be omitted or substituted from what is described. Thus, embodiments and aspects described herein may comprise or be combinable with elements or components of other embodiments and/or aspects despite not being expressly exemplified in combination, unless otherwise stated or an incompatibility is stated.

A social media system, as used herein, refers to forms of electronic communication (such as websites for social networking and microblogging) through which users create online communities to share information, ideas, personal messages, and other content (such as videos).

Influencers, as used herein, refers to a person with the ability to influence potential buyers of a product or service by promoting or recommending the items on social media. An influencer will typically have at least 10,000 followers. A beauty influencer is an influencer who specifically discusses and recommends beauty care products, including hair care products.

Hair routine, as used herein, refers to the events and sequence of events most often done by a consumer to his or her hair on a daily or weekly basis.

### Hair Code

Personality testing is a well-known thing. In one particularly well-known test, people complete a questionnaire about themselves and are subsequently assigned a four-letter code that connotes various attributes of their personality. Similarly, the present inventors have discovered a way to solicit information from consumers regarding their hair and scalp and then, using the information, categorize the consumer's hair and scalp type into a single code, called a hair code. With this hair code, plus additional information given by the consumer, the consumer can be given information about his or her hair and scalp, have products suggested that are particularly suited for him or her, and also be able to connect to other consumers that have the same hair code.

In one embodiment of the present invention, the method of providing a consumer a hair information tool involves obtaining information from the consumer. Some of the information from the consumer is related to attributes of the consumer's hair and scalp. For example, such attributes may include information about the hair type, such as straight, wavy, curly, or coily. Further information may relate to the hair texture, such as fine, medium, or coarse. More information may relate to the density of hair on the consumer's head, or the consumer may answer a question about porosity, or how quickly their hair soaks in water. Other information may relate to any scalp concerns the consumer may have.

Further information may be obtained from the consumer regarding the consumer's lifestyle. Lifestyle may include what kind of physical activities the consumer enjoys, such as swimming or using a sauna or spa, and whether the activities are indoors or outdoors. Lifestyle may also include geographic information (location), because factors about where the consumer lives, such as weather or pollution, can affect the consumer's hair and scalp. Lifestyle information may also include demographic information, like the consumer's age, gender, and ethnicity. And lifestyle information may also include the consumer's typical hair routine, such as use of rollers or hot tools, coloring, perms, or keratin, for example. And further, lifestyle information may also include the type of hair products the consumer is interested in or open to using, such as a cream, gel, mousse, dry shampoo, oil/serum, or hair spray, for example.

Other information may be obtained from the consumer regarding the consumer's preferences. For example, the consumers may suggest specific ingredients they are interested in, such as particular scents, which may be selected from various berries and fruits, or from flowers and herbs. The consumer may suggest further ingredients they may be interested in, such as argan oil, charcoal, coffee, green tea, honey, jojoba oil, sandalwood, and/or antioxidants. The consumer may also offer what, if any, ingredients they want to avoid in their haircare products. The consumer may be asked what challenges they feel their hair presents. The consumer may answer from a list presented to them, for example, of flat hair, undefined curls, damage or breakage, untamed frizz, dry or parched hair, removing build-up, staying clean between washes, and/or tangles. As appropriate, information may be obtained from the consumer regarding the consumer's beard.

The information from the consumer may be obtained via questions posed on a website on the internet. The hair information tool may be a computer-based system, comprising a hair code system.

The information obtained from the consumer may be used to generate a single code, or hair code, for the consumer. The hair code may comprise three parts, such as a code for hair type, a code for cuticle health, and a code for scalp health. The three codes together may define a final hair code.

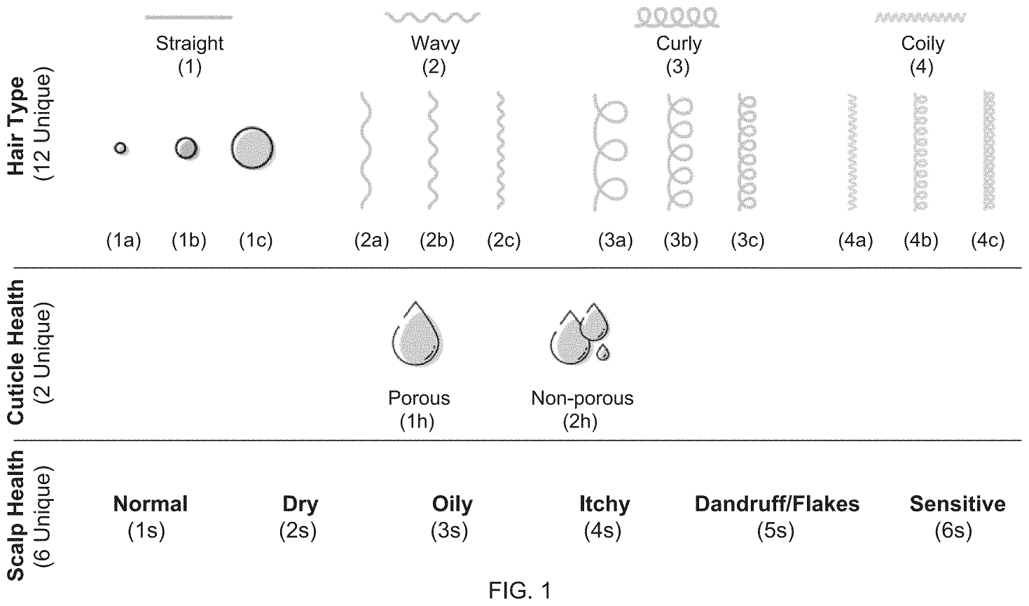

Generating the code for hair type involves a sequence of classifications, as illustrated in FIG. 1. The consumer may be asked to choose one of four selections having to do with the straightness or curliness of the consumer's hair, for example, (1) straight, (2) wavy), (3) curly, or (4) coily, as seen in FIG. 1. Based on this choice, the consumer may then select one of three further possibilities based on the texture or level of curliness of the hair (1a, 1b, 1c, 2a, 2b, 2c, 3a, 3b, 3c, 4a, 4b, or 4c). For example, in a choice among straight, wavy, curly, or coily hair, the consumer may select straight (1). Based on this response, the consumer is then asked whether their hair is fine (1a), medium (1b) or coarse (1c). In a different example, a consumer may select wavy (2). Choices are then offered regarding the level of waviness, with the consumer selecting among three drawings of waviness, 2a, 2b, or 2c. With four possibilities for the first component and three possibilities for the second component, 12 different combinations are generated.

As further seen in FIG. 1, for each of the 12 combinations discussed above, two possibilities may be generated related to whether the consumer considers their hair porous (1h) or non-porous (2h). This selection of cuticle health, combined with the 12 possible results of hair type, results in 24 different possible combinations. For each of these combinations, the consumer is given their hair personality, as shown in Table 1.

TABLE 1

| Hair Type | Cuticle Health | Code Output | Personality |
|---|---|---|---|
| 1a | 1h | 1a1h | City Sleek |
| 1a | 2h | 1a2h | Urban Sleek |
| 1b | 1h | 1b1h | Smooth Grooves |
| 1b | 2h | 1b2h | Smooth Streak |
| 1c | 1h | 1c1h | Straight of the Art |
| 1c | 2h | 1c2h | Straight Talk |
| 2a | 1h | 2a1h | Wave of Sunshine |
| 2a | 2h | 2a2h | Beach Chic |
| 2b | 1h | 2blh | Hang Loose |
| 2b | 2h | 2b2h | Weekend Waves |
| 2c | 1h | 2c1h | Tidal Babe |
| 2c | 2h | 2c2h | Shore Thing |
| 3a | 1h | 3a1h | In the Loop |
| 3a | 2h | 3a2h | Curve Appeal |
| 3b | 1h | 3b1h | Uptown Twirl |
| 3b | 2h | 3b2h | It Curl |
| 3c | 1h | 3c1h | A-List Twist |
| 3c | 2h | 3c2h | Spiral Crush |
| 4a | 1h | 4a1h | Carefree Coils |
| 4a | 2h | 4a2h | Karma Curl |
| 4b | 1h | 4b1h | All Natural |
| 4b | 2h | 4b2h | Play it Coil |
| 4c | 1h | 4c1h | Just for Kinks |
| 4c | 2h | 4c2h | Kink it Low Key |

Further information may then be obtained from the consumer regarding scalp concerns. For example, the consumer may choose whether they experience a normal scalp (1S), dry scalp (2S), oily scalp (3S), itchy scalp (4S), dandruff or flakes (5S), or a sensitive scalp (6S). These six possibilities combined with the previous 24 possibilities results in a total of 144 different possible combinations, one of which is the consumer's final hair code. The hair code may comprise the three components, each of which consists of a number and a letter. As shown in the Example below, a consumer's hair code may be 3a hair type, 2h cuticle health, and 2s scalp health. For each particular hair code, the consumer is provided some information about their hair type, cuticle health, and scalp health. The consumer is also invited to share their hair code on social media, such as facebook, instagram, or twitter, and to connect with other consumers who have the same hair code and to influencers or beauty influencers with the same hair code.

Based on information obtained from the consumer about their lifestyle and preferences, product recommendations may be made. Recommendations may be made based on a weighted algorithm, such as a “utility-based” (or “scoring-based”) recommendation system. In this type of a system, a calculation is made for each possible recommendation (producing a score for that option), and then recommendations are made based upon ranking the scores of all the possible recommendations.

Five product recommendations may be made to the consumer, one for shampoo, one for conditioner, and three other out of shower products. Each product is categorized with a “slot” type. For example, slot 1 may be shampoo, slot 2 may be conditioner, and slots 3, 4, and 5 may be out of shower products. Each slot has a different list of criteria that correspond with the questions and answers received from consumers. Below in Table 2 are the slot criteria. Points are assigned based on the associated slot type criteria list, as shown in Table 3 for slot 1, Table 4 for slot 2, and Table 5 for slots 3, 4, and 5. For example, if the consumer has met the “is free of” criteria, that is they have noted that there is a particular ingredient that they want to avoid in their products, the “is free of” criteria is assigned the appropriate point value based on the slot, which is +4 for slot 1, and +3 for slots 2, 3, 4, and 5. If the “is free of” criteria is not met by the consumer, that is, the consumer has not indicated that any particular ingredient should be avoided, then the “is free of” criteria is assigned the value of −50 points for all slots.

TABLE 2

| Slot 1 | Slot 2 | Slots 3, 4, 5 |
|---|---|---|
| hasScalpTag | hasScalpTag | hasFormCriteria |
| hasChallengeCriteria | hasChallengeCriteria | hasChallengeCriteria |
| hasRoutineCriteria | hasRoutineCriteria | hasRoutineCriteria |
| isFreeOf | hasCuticleCriteria | hasCuticleCriteria |
| hasIngredients | isFreeOf | isFreeOf |
| hasCuticleCriteria | hasIngredients | hasIngredients |
| hasActivityCriteria | hasActivityCriteria | hasHoldCriteria |
| hasLocationCriteria | hasLocationCriteria | hasFinishCriteria |
| hasGenderCriteria | hasGenderCriteria | hasActivityCriteria |
| hasEthnicityCriteria | hasEthnicityCriteria | hasLocationCriteria |
| hasHairTypeCriteria | hasHairTypeCriteria | hasGenderCriteria |
| | | hasEthnicityCriteria |
| | | hasHairTypeCriteria |

TABLE 3

| Slot 1 | Criteria Met | Criteria Unmet |
|---|---|---|
| hasScalpTag | +20 per tag | +0 no tag |
| | | −50 no tag with |
| | | ‘Head & Shoulders’ |
| | | Brand |
| hasChallengeCriteria | +6 pts | +0 pts |
| hasRoutineCriteria | +5 pts | +0 pts |
| isFreeOf | +4 pts | −50 pts |
| hasIngredients | +3 pts | +0 pts |
| hasHairTypeCriteria | +0 pts if none | −25 pts if not match |
| hasActivityCriteria | +1 pts | +0 pts |
| hasLocationCriteria | +1 pts for ‘UV >8.00’ | +0 pts |
| | +1 pts for ‘humidity >50’ | |
| | +1 pts for ‘wind >6’ | |
| | +1 pts for ‘pollution >12’ | |
| hasGenderCriteria | +0 pts if none | −10 pts if not match |
| hasEthnicityCriteria | +0 pts if none | −20 pts if not match |
| | +20 pts if match | |
| hasHairTypeCriteria | +25 pts | +0 pts |

TABLE 4

| Slot 2 | Criteria Met | Criteria Unmet |
|---|---|---|
| hasScalpTag | +20 per tag | +0 no tag |
| | | −50 no tag with |
| | | ‘Head & Shoulders’ |
| | | Brand |
| hasChallengeCriteria | +6 pts | +0 pts |
| hasRoutineCriteria | +5 pts | +0 pts |
| hasCuticleCriteria | +4 pts | +0 pts |
| isFreeOf | +3 pts | −50 pts |
| hasIngredients | +2 pts | +0 pts |
| hasActivityCriteria | +1 pts | +0 pts |
| hasLocationCriteria | +1 pts for ‘UV >8.00’ | +0 pts |
| | +1 pts for ‘humidity >50’ | |
| | +1 pts for ‘wind >6’ | |
| | +1 pts for ‘pollution >12’ | |
| hasGenderCriteria | +0 pts if none | −10 pts if not match |
| hasEthnicityCriteria | +0 pts if none | −20 pts if not match |
| | +20 pts if match | |
| hasHairTypeCriteria | +0 pts if none | −25 pts if not match |

TABLE 5

| Slot 3, 4, 5 | Criteria Met | Criteria Unmet |
|---|---|---|
| hasFormCriteria | +7 pts | +0 pts |
| hasChallengeCriteria | +6 pts | +0 pts |
| hasRoutineCriteria | +5 pts | +0 pts |
| hasCuticleCriteria | +4 pts | +0 pts |
| isFreeOf | +3 pts | −50 pts |
| hasIngredients | +2 pts | +0 pts |
| hasHoldCriteria | +1 pts | +0 pts |
| hasFinishCriteria | +1 pts | +0 pts |
| hasActivityCriteria | +1 pts | +0 pts |
| hasLocationCriteria | +1 pts for ‘UV >8.00’ | +0 pts |
| | +1 pts for ‘humidity >50’ | |
| | +1 pts for ‘wind >6’ | |
| | +1 pts for ‘pollution >12’ | |
| hasGenderCriteria | +0 pts if none | −10 pts if not match |
| hasEthnicityCriteria | +0 pts if none | −20 pts if not match |
| | +20 pts if match | |
| hasHairTypeCriteria | +0 pts if none | −25 pts if not match |

Product recommendations are then ranked and selected based on assigned points for each slot. For certain categories, such as hair type, gender, and ethnicity, the selected products are checked to see if they match the information given by the consumer. For example, a product for men would not be a match for a woman. If not a match in these categories, points are adjusted accordingly, and a more appropriate product is selected for the recommendation. So while points are initially tabulated based on criteria met/unmet, a match point adjustment may be made as a later check on the product selections to make sure they are consistent with the consumer's information. After the points are adjusted for matching/not matching, the product recommendations are made to the consumer.

For each product recommendation, some information is given about the product and an explanation is provided to the consumer about why the product is a match to the particular attributes and preferences submitted by the consumer. Local stores are provided that carry the recommended products, along with the price of the products. Further, information may be provided to the consumer such as tips regarding hair wash and styling products, beard wash and styling products, scalp care products, and combinations thereof.

Consumers may share their hair code on social media, such as Instagram, Facebook or twitter. Consumers are also able to connect with other people who have the same hair code. For example, an Instagram account of a person with the same hair code is provided, and the consumer can choose to follow the person. In some cases, the consumer may be connected via social media to a beauty influencer, or a person who is known for their ability to influence potential buyers of, for example, hair care products due to their own promotions and recommendations on social media. In this way, the hair code consumer can connect not just to any social media influencer who discusses and recommends hair care products, but to someone with the same hair type, and learn from them what products they use and recommend for their particular hair.

Further, the consumer's hair code may be used in combination with a smart mirror, a smart hair dryer, or other smart hair tools to generate product and styling recommendations for the consumer, for example, such as those described in U.S. patent applications Ser. Nos. 15/646,154 and 15/987,770 or KR 20170117262.

### EXAMPLE

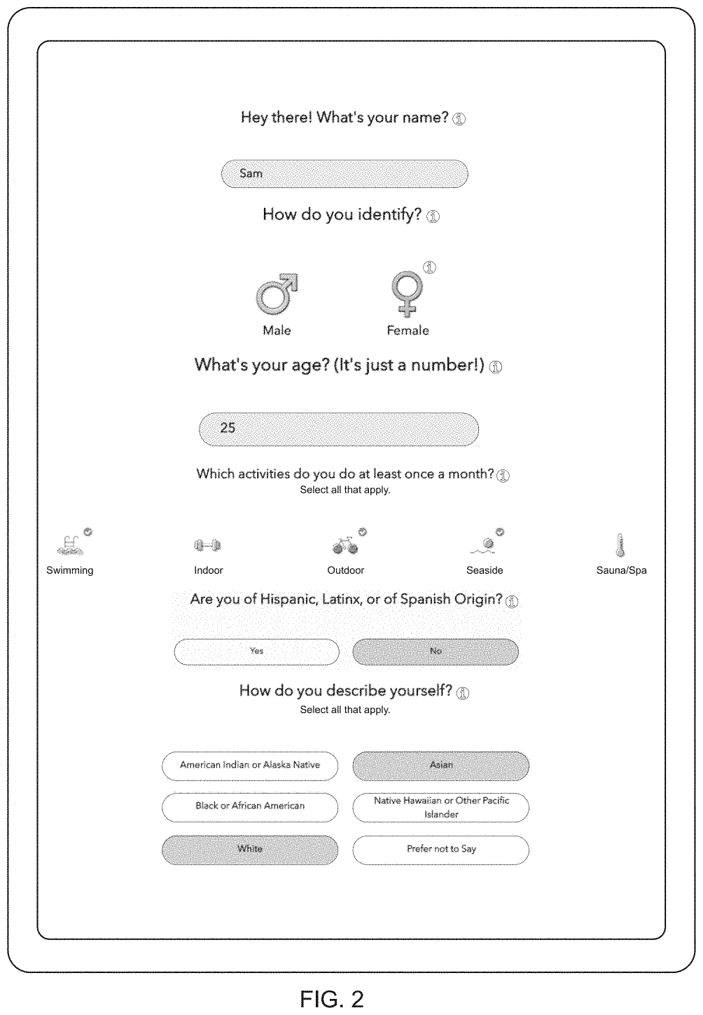

The following, as shown in FIGS. 2-8, is an example of a consumer using the claimed method to generate a hair code, product recommendations, and suggestions for connections to others through social media. In this case, the consumer may use a website to enter the information.

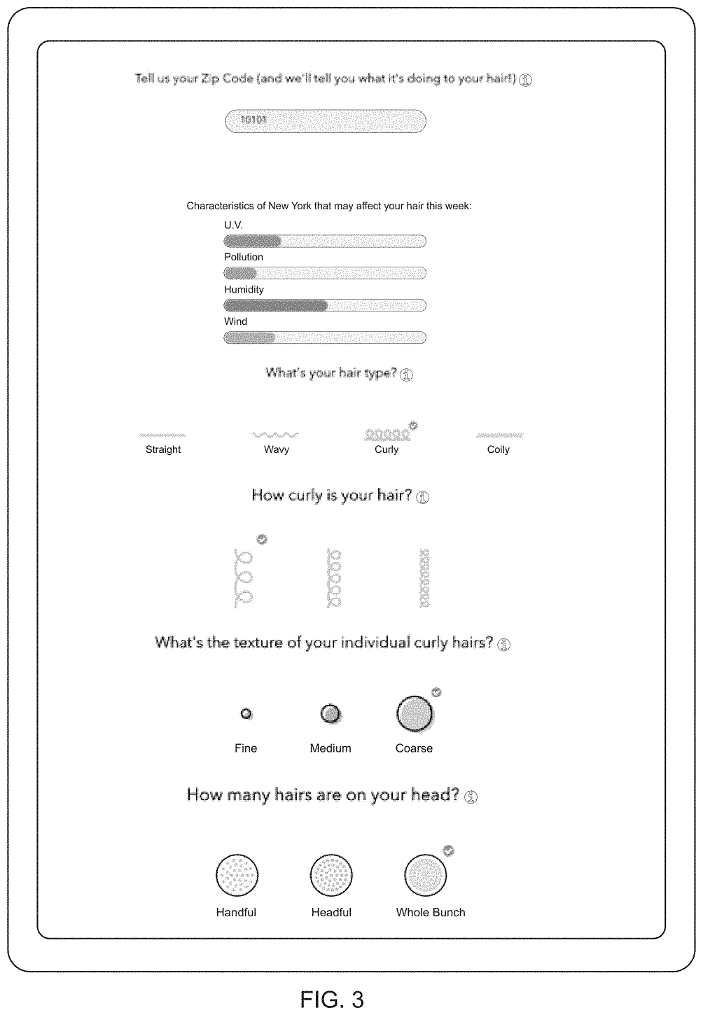

As shown in FIG. 2, the consumer is asked their name, gender, age, and ethnicity, and also what activities they do at least once a month. The consumer in the Example provides she is a 25 year old female named Sam, not of Hispanic, Latinx, or Spanish origin, who describes herself as Asian and White. The consumer then provides that she goes swimming and is outdoors at the seaside at least once a month. As shown in FIG. 3, the consumer is then asked her zip code. The consumer provides a zip code of 10101, and characteristics of her New York location are then shown that may affect her hair this week. The consumer then provides that she has curly hair, with a coarse texture and thick density.

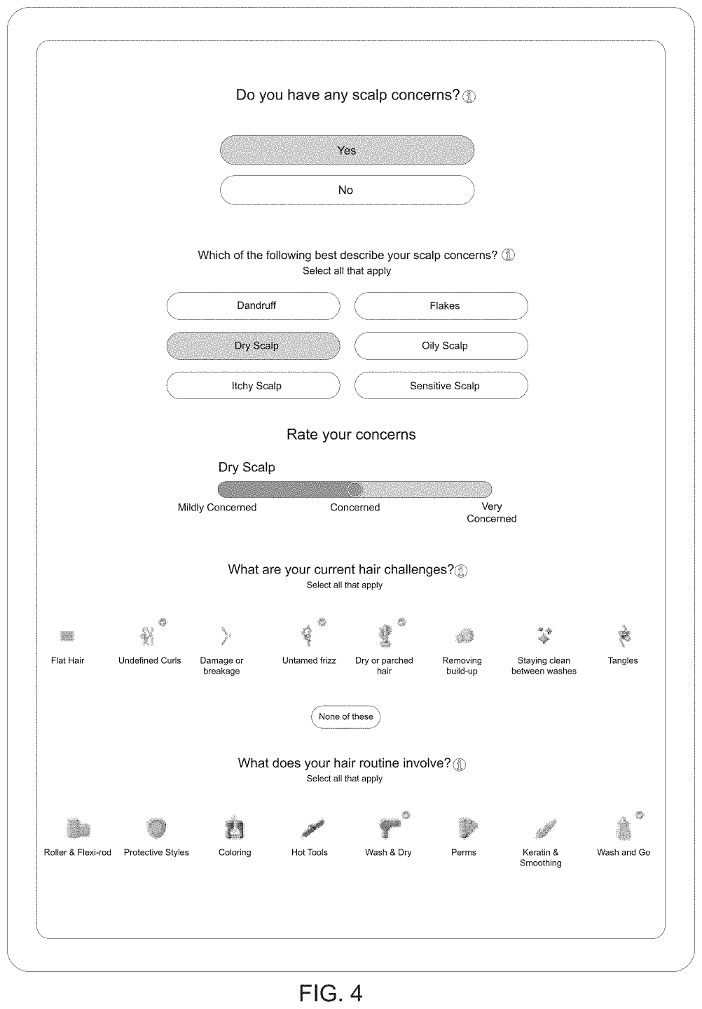

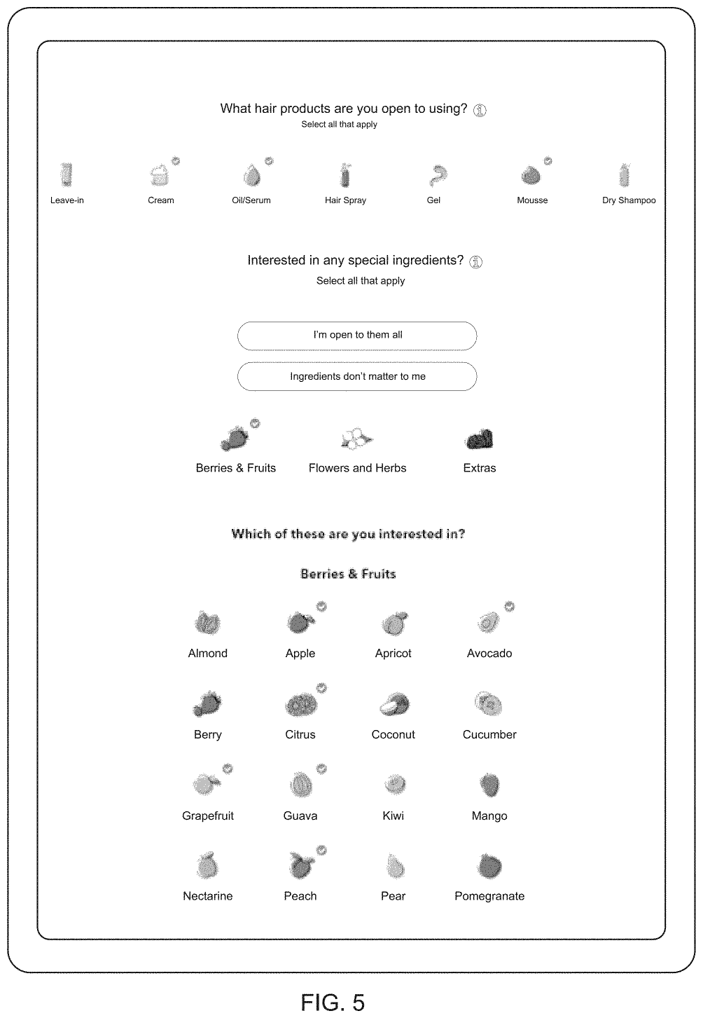

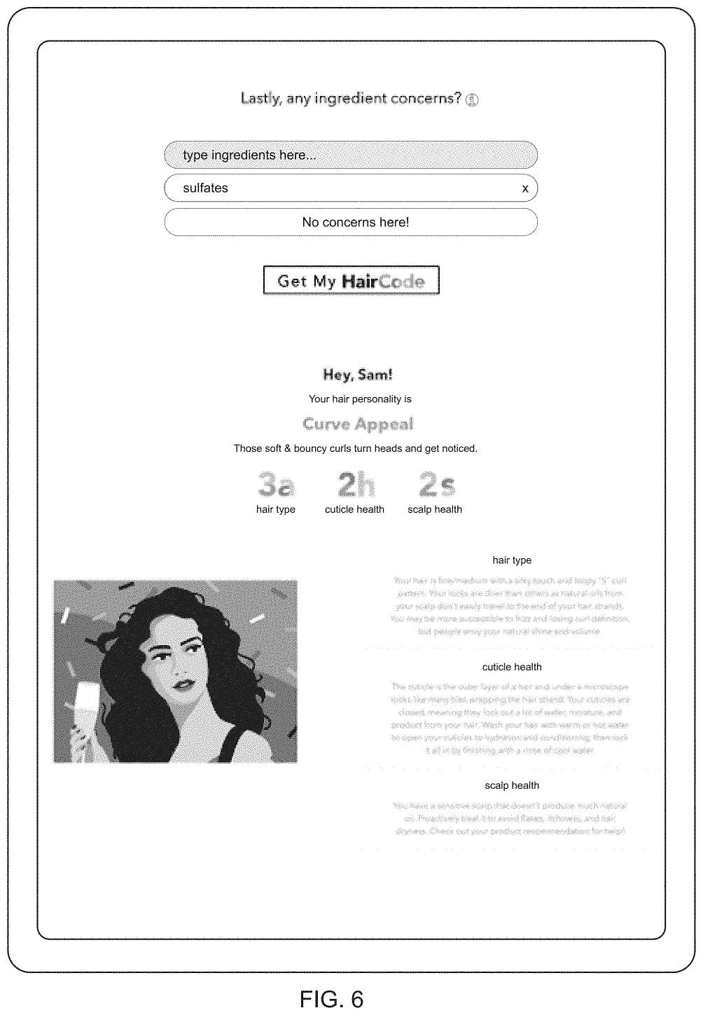

As FIG. 4 illustrates, further inputs indicate that the consumer is concerned about a dry scalp, and that her current hair challenges involve undefined curls, untamed frizz, and dry or parched hair. Her hair routine involves washing and drying or wash and go. As shown in FIG. 5, hair product types the consumer is open to using include a cream, an oil/serum, and/or a mousse. In terms of special ingredients, the consumer selects berries and fruits, specifically apple, avocado, citrus, grapefruit, guava, or peach. And finally, as shown in FIG. 6, the consumer is able to offer that she does not want any sulfates in her products.

As shown in FIG. 6, the consumer then requests to get her hair code, and is provided that her hair code is 3a, 2h, 2s, or “Curve Appeal”. The 3a is the hair type, the 2h is the cuticle health, and the 2s is the scalp health. The consumer is provided brief messages relating to each of her hair type, cuticle health, and scalp health.

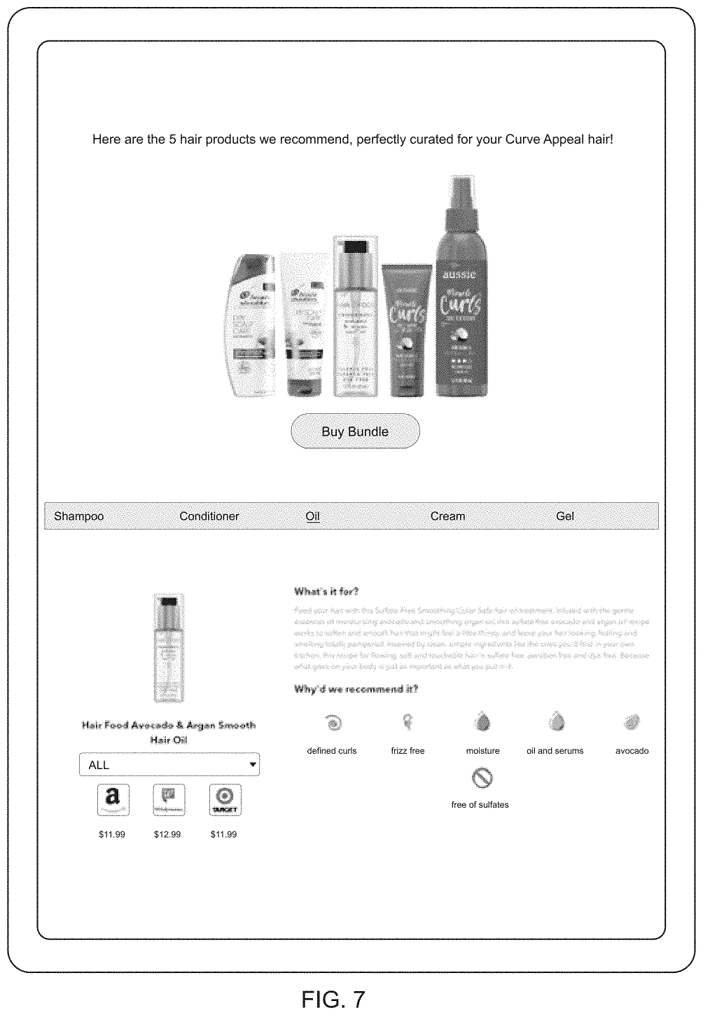

As illustrated in FIG. 7, five hair products are recommended for the consumer, including a shampoo, conditioner, an oil, cream, and a gel. In various embodiments, the number of product recommendations made may be 1, 2, 3, 4, 5, 6, 7, or 8. For each product, there is an explanation provided for how the recommended product can address the consumer's particular needs and preferences. Also provided are stores that will carry each of the products and their costs.

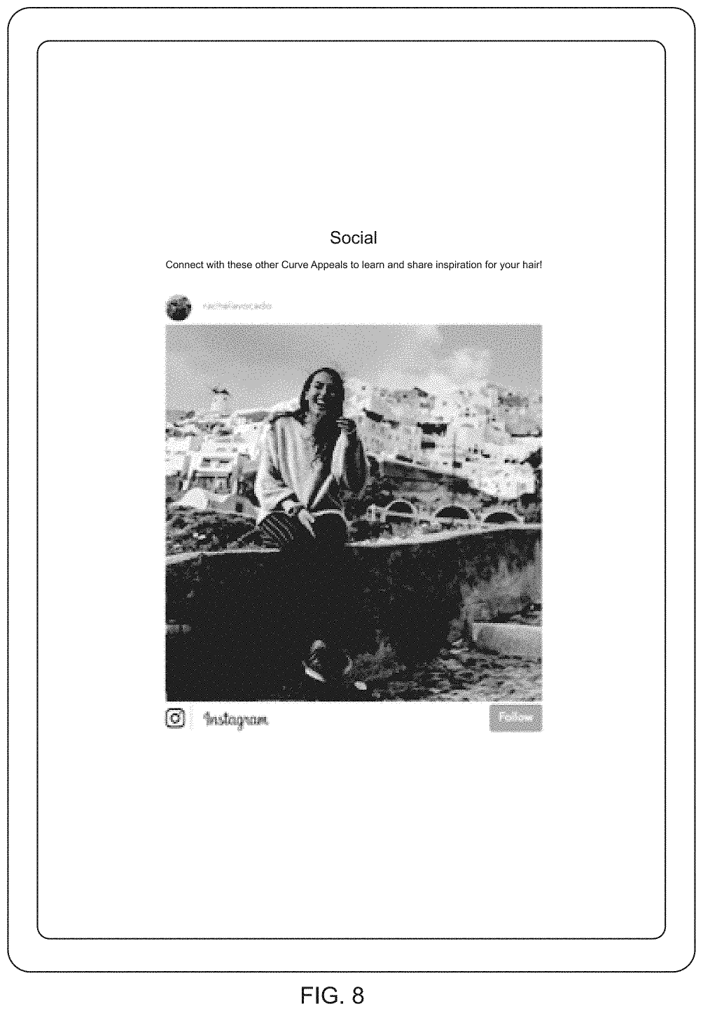

As shown in FIG. 8, the consumer will also be provided with at least one social connection, that is, a way to connect to a different consumer who has the same hair code. The connection may be provided in any social media context, for example, through Instagram. In the Example, the consumer may choose to follow or otherwise connect to a fellow “Curve Appeal” consumer through Instagram.

A computer program, or computer-based system, comprising the hair code system, is provided for recommendations of hair care products and connection to similar consumers. The computer program may be tangibly embodied in a non-transitory computer readable medium, the computer program providing instructions configured to cause database processing apparatus to provide a list of questions to the consumer, allow for consumers to input their responses to the questions, provide a database of hair care product parameters having set values, provide a product matrix assigned a numerical score for each parameter value, provide a weighting factor for each product parameter input, calculate a product score and calculate a consumer score for each question, provide a hair code to the consumer, provide a recommendation for five slots of hair care products, and provide connection to other consumers who share the same hair code.

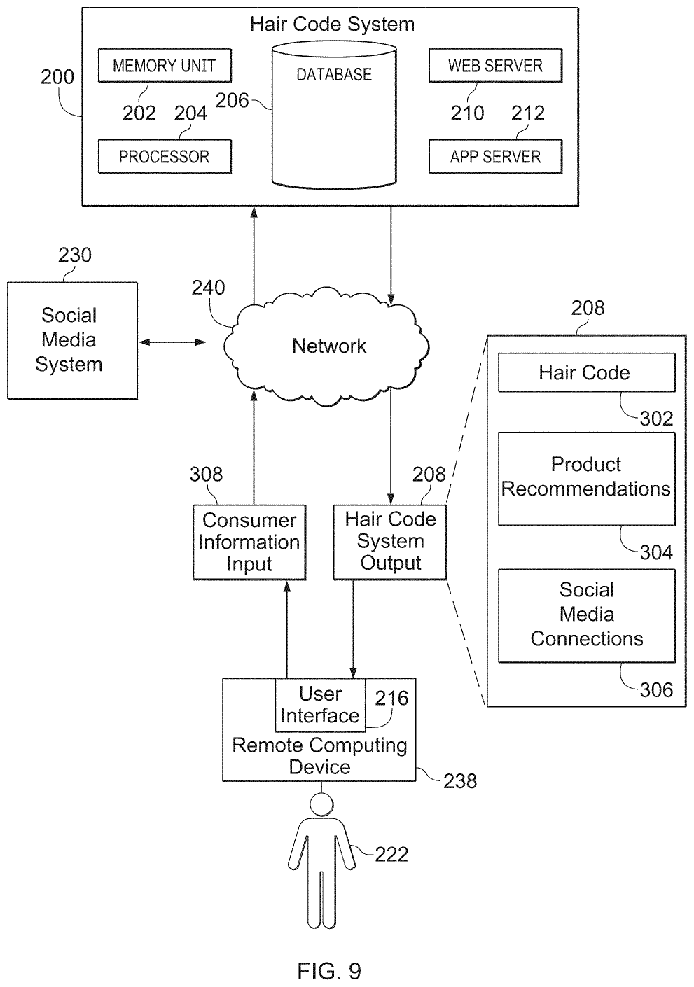

FIG. 9 is a flowchart representing the flow of information to and from the consumer and the hair code system. The consumer 222 is depicted interacting with the system in accordance with a non-limiting embodiment, giving information about themselves, and seeking information and recommendations for hair care products, and seeking connections to others via social media.

The hair code system 200 may include a memory unit 202, a processor 204, and a database 206 for storing a plurality of models that include hair care product parameters and values. In accordance with various embodiments, the hair code system 200 can also include one or more computer servers, which can include one or more web servers, one or more application servers, and/or one or more other types of servers. For convenience, only one web server 210 and one application server 212 are depicted in FIG. 9, although one having ordinary skill in the art would appreciate that the disclosure is not so limited. The servers 210, 212 can be comprised of processors (e.g., CPUs), memory units (e.g., RAM, ROM), non-volatile storage systems (e.g., hard disk drive systems), and other elements.

In some embodiments, the web server 210 can provide a graphical web user interface, such as the user interface 216, through which various users or consumers 222 can interact with the hair code system 200. The graphical web user interface can also be referred to as a client portal, client interface, graphical client interface, and so forth. The web server 210 can accept requests, such as HTTP/HTTPS requests, from various entities, such as HTTP/HTTPS responses, along with optional data content, such as web pages (e.g., HTML documents) and linked objects (such as images, video, and so forth). The application server 212 can provide a user interface, such as the interface 216, for users who do not communicate with the hair code system 200 using a web browser. Such users can have special software installed on their computing devices to allow the user to communicate with the application server 212 via a communication network.

As shown in FIG. 9, a consumer 222 can interact with the hair code system 200 via a remote computing device 238. The remote computing device 238 can be any type of computer device suitable for communication over the network, such as a wearable computing device, a mobile telephone, a tablet computer, a device that is a combination handheld computer and mobile telephone (sometimes referred to as a “smart phone”), a personal computer (such as a laptop computer, netbook computer, desktop computer, and so forth), or any other suitable networked communications device, such as personal digital assistants (PDA), mobile gaming devices, or media players, for example.

The remote computing device 238 can, in some embodiments, provide a variety of applications for allowing the consumer 222 to accomplish one or more specific tasks using the hair code system 200. Applications can include, without limitation, a web browser application (e.g., INTERNET EXPLORER, MOZILLA, FIREFOX, SAFARI, OPERA, NETSCAPE NAVIGATOR) telephone application (e.g., cellular, VoIP, PTT), networking application, messaging application (e.g., e-mail, IM, SMS, MMS, BLACKBERRY Messenger), and so forth. The remote computing device 238 can comprise various software programs such as system programs and applications to provide computing capabilities in accordance with the described embodiments. System programs can include, without limitation, an operating system (OS), device drivers, programming tools, utility programs, software libraries, application programming interfaces (APIs), and so forth. Exemplary operating systems can include, for example, a PALM OS, MICROSOFT OS, APPLE OS, ANDROID OS, UNIX OS, LINUX OS, SYMBIAN OS, EMBEDIX OS, Binary Run-time Environment for Wireless (BREW) OS, JavaOS, a Wireless Application Protocol (WAP) OS, and others.

The remote computing device 238 can include various components for interacting with the hair code system 200. The remote computing device 238 can include components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, depth sensor, IR projector, stereoscopic cameras, gyroscope, accelerometer, and so forth. The consumer 222 can interact with the hair code system 200 via a variety of other electronic communications techniques, such as, without limitation, HTTP requests, in-app messaging, and short message service (SMS) messages. The electronic communications can be generated by a specialized application executed on the remote computing device 238 or can be generated using one or more applications that are generally standard to the remote computing device 238. The applications can be included or be implemented as executable computer program instructions stored on computer-readable storage media such as volatile or non-volatile memory capable of being retrieved and executed by a processor to provide operations for the remote computing device 238. The memory can also store various databases and/or other types of data structures (e.g., arrays, files, tables, records) for storing data for use by the processor and/or other elements of the remote computing device 238.

As shown in FIG. 9, a consumer 222 can interact with the hair code system 200 via a remote computing device 238 having a suitable user interface 216. The user interface 216 can be any suitable device or method capable of communicating information to the user or consumer 222, such as the display screen of a computing device, a text message, an email message, an in-app message, and so forth. The consumer may provide the consumer information input 308 through the use of the user interface 216.

In FIG. 9, the consumer information input 308 is provided to the hair code system 200 via an electronic communications network 240. The communications network can include a number of computer and/or data networks, including the Internet, LANs, WANs, GPRS networks, LTE networks, etc., and can comprise wired and/or wireless communication links.

Still referring to FIG. 9, upon receipt of the consumer information input, which can be done in many iterations, the hair code system 200 can perform processing as described above in order to generate a hair code system output 208. The hair code system output 208 may include a hair code 302, hair care product recommendations 304, and social media connections 306 for the consumer 222. Through the network 240, the hair code system may communicate with a social media system 230, providing the social media connections 306 to the consumer. The hair code, product recommendations, and social media connections can then be sent via the network 240 for display on the user interface 216 of the remote computing device 238. The scope, format, and content of the hair code system output 208 can vary. In the illustrated embodiment, the hair code system output includes a hair code 302, hair care product recommendations 304, and social media connections 306 for the consumer 222, although this disclosure is not so limited.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” All numeric values (e.g., dimensions, flow rates, pressures, concentrations, etc.) recited herein are modified by the term “about”, even if not expressly so stated with the numeric value.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of providing a consumer a hair code, comprising the steps of:
(a) obtaining information regarding attributes of the consumer's hair and scalp;
(b) using the information to generate a hair type code, a cuticle health code, and a scalp health code; and
(c) combining the hair type code, cuticle health code, and scalp health code to create a hair code.

2. The method of claim 1, wherein the information regarding attributes of the consumer's hair is selected from the group consisting of curliness, texture, density, porosity, and combinations thereof, and wherein the information regarding an attribute of the consumer's scalp is selected from the group consisting of normal, dry, oily, itchy, dandruff flakes, and sensitive.

3. The method of claim 1, wherein the hair code has three letters and three digits.

4. The method of claim 1, further comprising the following steps:
(d) obtaining information from the consumer from at least one category selected from the group consisting of physical activities, age, gender, ethnicity, location, hair routine, hair products previously used, ingredients, allergens, health issues, product forms, styling preferences, and combinations thereof; and
(e) using a computer-based system to combine the hair code with the information obtained in (d) to make hair care product recommendations.

5. The method of claim 4, wherein at least five product recommendations are made to the consumer.

6. The method of claim 4, further comprising the step of connecting the consumer to other consumers with the same hair code.

7. The method of claim 6, wherein connecting the consumer to other consumers is done via social media.

8. The method of claim 6, further comprising the step of providing the consumer with information particular to the consumer's hair code.

9. The method of claim 8, wherein the information is selected from the group consisting of hair wash and styling products, styling recommendations, beard wash and styling products, scalp care products, and combinations thereof.

10. The method of claim 6, further comprising the step of connecting the consumer to beauty influencers with the same hair code.

11. The method of claim 4, wherein the hair product recommendations are generated by use of a weighted algorithm.

12. The method of claim 1, wherein the hair code is used in combination with a smart hair tool to generate product and styling recommendations for the consumer.

13. The method of claim 1, wherein information is also obtained regarding attributes of the consumer's beard.

14. A computer-based method of providing a consumer a hair information tool, comprising the steps of:
(a) obtaining information regarding attributes of the consumer's hair and scalp;
(b) using the information obtained in (a) to generate a hair code for the consumer;
(c) obtaining information in at least one category of consumer attributes selected from the group consisting of lifestyle and preferences;
(d) using a weighted algorithm to recommend hair care products to the consumer based on the hair code and the information obtained in (c); and
(d) connecting the consumer to other consumers with the same hair code.

15. The method of claim 14, wherein the information regarding attributes of the consumer's hair is selected from the group consisting of curliness, texture, density, porosity, and combinations thereof and the information regarding an attribute of the consumer's scalp is selected from the group consisting of normal, dry, oily, itchy, dandruff flakes, and sensitive.

16. The method of claim 14, wherein the hair code comprises a hair type code, a cuticle health code, and a scalp code.

17. The method of claim 14, wherein the information regarding attributes of the consumer's lifestyle is selected from the group consisting of physical activities, age, gender, ethnicity, location, hair routine, hair products previously used, and combinations thereof, and the information regarding attributes of the consumer's preferences is selected from the group consisting of ingredients, allergens, health issues, product forms, styling preferences, and combinations thereof.

18. The method of claim 14, wherein connecting the consumer to other consumers is done via social media.

19. The method of claim 14, wherein the hair code is used in combination with a smart hair tool to generate product and styling recommendations for the consumer.

20. A computer program for providing information, recommending hair care products, and connecting a consumer to other consumers, the computer program configured to:
provide instructions configured to cause database processing apparatus to provide a list of questions to the consumer;
allow for consumers to input their responses to the questions;
provide a database of consumer parameters having set values and hair care product parameters having set values;
provide a product matrix assigned a numerical score for each consumer and hair care product parameter value;
provide a weighting factor for each parameter input;
calculate a product score and calculate a consumer score for each question;
provide a hair code to the consumer;
provide a recommendation of at least five types of hair care products;
and provide a connection to other consumers who have the same hair code.
